(19) United States
(12) Patent Application Publication
(10) Pub. No.: US 2008/0261852 A1
(43) Pub. Date: Oct. 23, 2008

(54) Bleach Reinforcer Combination for Use in Washing and Cleaning Agents

(75) Inventors: Heike Schirmer-Ditze, Dusseldorf (DE); Doris Dahlmann, Dusseldorf (DE); Birgit Middelhauve, Monheim (DE)

Correspondence Address: CONNOLLY BOVE LODGE & HUTZ LLP, PO BOX 2207, WILMINGTON, DE, 19899-2207, US

(73) Assignee: HENKEL KGaA, DUSSELDORF (DE)

(21) Appl. No.: 11/596,957

(22) PCT Filed: May 7, 2005
(86) PCT No.: PCT/EP05/04973

§ 371 Date: Dec. 29, 2006

(30) Foreign Application Priority Data
May 17, 2004 (DE) 10-2004-024-816.8

(51) Int. Cl. C11D 7/54

(52) U.S. Cl. 510/311; 510/376

(57) ABSTRACT

The performance of peroxide compounds, in particular when associated with bleaches for washing ink stains out of textiles, can be improved by a composition comprising: (i) a peroxygen-containing bleaching agent, (ii) a bleach activator selected from the group consisting of amide bleach activators, sulfonyl phenyl ester bleach activators, quaternary nitrogen substituted acetonitrile bleach activators, and mixtures thereof, and (iii) a compound selected from the group consisting of ligands corresponding to the general formula (I), bleach catalysts corresponding to the general formula (II), and mixtures thereof:

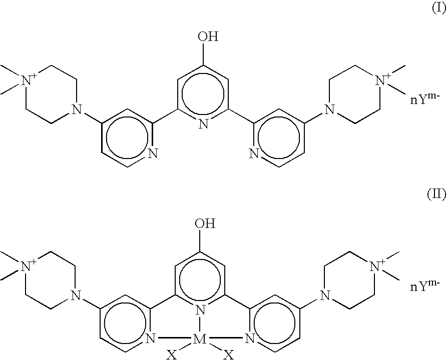

wherein Y^{m-} represents an anion, M represent a manganese or iron atom, each X independently represents an inorganic ligand and the mathematical product of m and n equals 2.

The present invention relates to the use of a combination of a bleach activator with a terpyridine compound that is able to form complexes with iron- and manganese ions, or to a correspondingly prepared iron- or manganese complex for activating peroxygen compounds and/or air oxygen, in particular for bleaching colored stains during the washing of fabrics, and to detergents, cleansing agents and disinfectants that comprise such bleach-boosting combinations.

Inorganic peroxygen compounds, particularly hydrogen peroxide and solid peroxygen compounds that dissolve in water and release hydrogen peroxide, such as sodium perborate and sodium carbonate perhydrate, have long been used as oxidizing agents for disinfection and bleaching purposes. The oxidizing action of these substances in dilute solutions is strongly dependent on the temperature; thus, for example, a sufficiently rapid bleaching of soiled fabrics by H₂O₂ or perborate in alkaline bleaching liquor is only achieved at temperatures above about 80° C. The oxidizing action of the inorganic peroxygen compounds at lower temperatures can be improved by the addition of bleach activators that are capable of yielding peroxycarboxylic acids under the given perhydrolysis conditions, and the numerous proposals known from the literature, principally from the classes of materials N- or O-acyl compounds, for example the reactive esters known from the British patent GB 836 988, polyacylated alkylenediamines, particularly N,N,N′,N′-tetraacetylethylenediamine (TAED), acylated glycolurils, particularly tetraacetylglycoluril, N-acylated hydantoins, hydrazides, triazoles, hydrotriazines, urazoles, diketopiperazines, sulfurylamides and cyanurates, also carboxylic acid anhydrides, particularly phthalic anhydride, carboxylic acid esters, particularly sodium nonanoyloxy benzenesulfonate (NOBS), sodium isononanoyloxy benzenesulfonate, O-acylated sugar derivatives, such as pentaacetylglucose, and N-acylated lactams, such as N-benzoyl caprolactam. The bleaching action of aqueous peroxide wash liquor can be increased so much by the addition of these substances that already at temperatures of about 60° C. there is essentially the same activity as for the peroxide wash liquor alone at 95° C.

Using a differentiating approach, it was observed, however, that under fabric washing conditions, such bleach activators that release relatively short chain peroxycarboxylic acids (most important example of this is TAED) exhibit a particularly pronounced efficiency against hydrophilic colored stains, whereas bleach activators that release relatively longer chain peroxycarboxylic acids (an example of this is NOBS) possess a higher efficiency against hydrophobic colored stains. Largely to achieve on average a high bleaching performance for all possible stains, the addition of mixtures of bleach activators that release percarboxylic acids with different chain lengths has been proposed on various occasions, for example in the international patent application WO 96/17920 A2 or the European patent application EP 0 257 700 A2.

In attempts for energy-saving washing and bleaching processes, washing temperatures significantly below 60° C., particularly below 45° C. down to cold water temperature have also grown in importance over the last few years.

At these low temperatures the activity of the activator compounds known up to now generally noticeably decreases. Therefore, there has been no lack of effort to develop more active activators for this temperature range. However, in specific cases one has to note that a highly active low-temperature bleach activator loses its efficiency at medium or high temperatures, in that higher demands on the cleaning performance of the detergent or cleansing agent can similarly require an increased bleaching performance from the pure oxidizing agent.

On various occasions, the addition of transition metal compounds, particularly transition metal complexes, has also been proposed to increase the oxidizing strength of peroxygen compounds or also air oxygen in detergents and cleansing agents. The transition metal compounds proposed for this purpose include, for example, salen complexes of manganese, iron, cobalt, ruthenium or molybdenum known from the German patent application DE 195 29 905 and their analogous N-compounds known from the German patent application DE 196 20 267, the carbonyl complexes of manganese, iron, cobalt, ruthenium or molybdenum known from the German patent application DE 195 36/082, the nitrogen-containing tripod ligand complexes of manganese, iron, cobalt, ruthenium, molybdenum, titanium, vanadium and copper known from the German patent application DE 196 05 688, the ammine complexes of cobalt, iron, copper and ruthenium known from the German patent application DE 196 20 411, the manganese, copper and cobalt complexes known from the German patent application DE 44 16 438, the cobalt complexes known from the European patent application EP 0 272 030, the manganese, iron, cobalt and copper complexes known from the European patent application EP 0 392 592, the cobalt complexes known from the international patent applications WO 96933859, WO 96/23860 and WO 96/23861 and the manganese complexes described in the European patent EP 0 443 651 or the European patent applications EP 0458 397, EP 0 458 398, EP 0 549 271, EP 0 549 272, EP 0 544 490 and EP 0 544 519. The bleach activating combination of active principles, obtainable according to the European patent application EP 0 832 969, is also to be cited here. Combinations of bleach activators and transition metal bleaching catalysts are known, for example, from the international patent application WO 95/27775 and the German patent application DE 196 13 103, relating to transition metal complexes that are electrochemically oxidizable in defined regions of potential with the highest possible current density.

The international patent application WO 2004/007657 relates to certain manganese, titanium, iron, cobalt, nickel or copper complexes with a terpyridine ligand that is substituted with at least one group carrying a quaternary nitrogen atom, and their use as catalysts for oxidation reactions. This use of the complexes can also result through a detergent agent, cleansing agent, disinfectant agent or bleaching agent that comprises the complexes, wherein conventional bleach activators are also cited among the additional usual ingredients of such agents.

Surprisingly, it has now been found that the combination of certain bleach activators, namely those of the amide type, the sulfonyl phenyl ester type and the type of quaternary nitrogen substituted acetonitriles with certain manganese or iron complexes, namely those with a ligand of the terpyridine type described below, exhibit an excellent bleach boosting action and in addition, this bleach boosting effect is retained over the entirety of the required temperature profile of a detergent or cleansing composition, whereby the addition of the composition or the joint addition of its abovementioned components does not damage the treated fabrics any more than would be the case when commercially available agents are added.

Accordingly, a subject matter of the invention is the use of a combination of peroxygen-containing bleaching agents, bleach activators of the amide type, the sulfonyl phenyl ester type and/or of the type of acetonitriles substituted with quaternary nitrogen, and a bleach catalyst of the general formula (II),

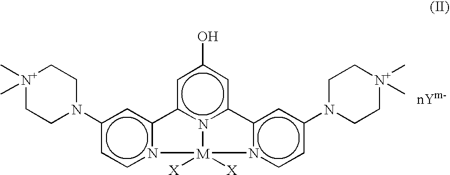

in which M stands for manganese or iron, X for an inorganic ligand and Y^{m-} for an anion and the product (m·n) equals 2, for bleaching colored stains during the washing of fabrics, particularly in aqueous, surfactant-containing liquors. A further subject matter of the invention is the corresponding use for the simultaneous or alternative disinfection of the washing.

The inventively aimed success also occurs when the complex in accordance with formula (II) is not added, but rather only the corresponding terpyridine ligands, and the wash water comprises iron ions and/or manganese ions, wherein the oxidation state of the cited metals is not normally important due to the usually rapid adjustment of the redox equilibrium among the various oxidation states present in the wash water. Accordingly, a subject matter of the invention is the use of a combination of peroxygen-containing bleaching agent, bleach activators of the amide type, the sulfonyl phenyl ester type and/or of the type of quaternary nitrogen substituted acetonitriles, and a compound according to formula (I),

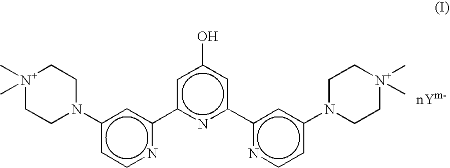

in which Y^{m-} stands for an anion and the product (m·n) equals 2, for bleaching colored stains and/or disinfection of the washing during the washing of fabrics, in aqueous, in particular surfactant-containing liquor that comprises manganese ions and/or iron ions.

In a compound according to formula (I) or formula (II), the anion (Y^{m-}) is preferably an organic anion, for example citrate, oxalate, tartrate, formate, a C₂₋₁₈ carboxylate, a C₁₋₁₈ alkyl sulfate, in particular methosulfate, or a corresponding alkane sulfonate. In a compound according formula (II), the inorganic ligand (X) is preferably a halide, particularly chloride, perchlorate, tetrafluoroborate, hexafluorophosphate, nitrate, hydrogen sulfate, hydroxide or hydroperoxide.

The use according to the invention can be particularly easily realized by adding a detergent, cleansing composition or disinfectant composition that comprises peroxygen-containing bleaching agent, bleach activator of the cited type and a compound according to formula (I) or a bleach catalyst according to formula (II), besides the usual ingredients that are compatible with the bleach activator and the cited compound or the bleach catalyst. Accordingly, these compositions are further subject matters of the invention.

The compositions according to the invention preferably comprise 0.01 wt. % to 2 wt. %, particularly 0.1 wt. % to 1 wt. % of the compound according to formula (I). When the composition comprises a compound according to formula (I), then the composition additionally comprises a manganese and/or iron salt and/or a manganese and/or iron complex without a ligand that corresponds to the compound according to formula (I). Then the molar ratio of manganese or iron or the sum of manganese and iron to the compound according to formula (I) is in the range from 0.001:1 to 2:1, particularly 0.01:1 to 1:1. In a further preferred embodiment, the compositions according to the invention comprise 0.01 wt. % to 1.5 wt. %, particularly 0.05 wt. % to 1 wt. % of a bleach catalyst according to formula (II).

Suitable peroxygen compounds particularly include organic peracids or peracid salts of organic acids, such as phthalimidopercaproic acid, perbenzoic acid or salts of diperoxydodecanedioic acid, hydrogen peroxide and inorganic salts that liberate hydrogen peroxide under the washing or cleaning conditions, such as perborate, percarbonate and/or persilicate. Here, hydrogen peroxide can also be produced with the help of an enzymatic system, i.e. an oxidase and its substrates. If it is intended to use solid peroxygen compounds, then they can be used in the form of powders or pellets, which in principle can also be encapsulated by known methods. Alkali percarbonate, alkali perborate monohydrate, alkali perborate tetrahydrate or hydrogen peroxide in the form of aqueous solutions that comprise 3 wt. % to 10 wt. % hydrogen peroxide are particularly preferably used. In particular the inventive detergents or cleansing agents comprise peroxygen compounds in amounts of preferably up to 50 wt. %, particularly from 5 wt. % to 30 wt. %, whereas the inventive disinfectants comprise preferably from 0.5 wt. % to 40 wt. %, particularly from 5 wt. % to 20 wt. % peroxygen compounds.

The bleach activator of the amide type as the preferred additional component of the combination used according to the invention or of the composition according to the invention is preferably a derivative of ammonia or of a mono- or bis-alkylamine. It is preferably selected from the compounds according to formula (III),

(R¹—CO—)ₙX (III)

in which R¹ stands for an aryl, alkyl, alkenyl or cycloalkyl group containing 1 to 10 carbon atoms, n stands for a number from 1 to 4 and X for a nitrogen-containing leaving group with a direct bond between on the one hand nitrogen and on the other hand the acyl group R¹—CO, as well as their mixtures. Compounds of formula (III) with R¹=phenyl, C₁- to C₅ alkyl, 9-decenyl and their mixtures, wherein the alkyl groups can be linear or branched, are preferred. Among the compounds of formula (III) with linear groups R¹, those containing 1 to 9 carbon atoms are particularly preferred. These compounds according to formula (III) can be manufactured using known processes by N-acetylation of the corresponding unsubstituted compounds HₙX with reactive R¹—CO derivatives, for example acid chlorides. Preferred nitrogen-containing leaving groups X are those in which the nitrogen carries at least one additional acyl group besides the cleavable acyl group R¹—CO—. Examples of these types of compounds according to formula (III) are the triacetylation products of ammonia and the diacetylation products of primary alkylamino groups, such as those of ethylenediamine. In the case where the cited at least one additional acyl group is not also an acyl group R¹—CO—, then it is preferred for a graduated perhydrolysis activity that the corresponding peroxycarboxylic acid is largely formed only from the group R¹—CO—. This can be achieved when the nitrogen that carries the group R¹—CO— in the compound according to formula (III) is also part of a cyclic amide or imide structure. The last named compounds can also be referred to as acylamides or acylimides, respectively, wherein the part name “acyl” refers to the group R¹—CO—. The amide part of such acylamides preferably consists of an optionally substituted caprolactam or valerolactam group and the imide part of such acylimides preferably consists of a succinimide, maleinimide or phthalimide group, these groups being optionally substituted with C₁- to C₄ alkyl, hydroxyl, COOH— and/or SO₃H— groups, wherein the last named substituent groups can also be present in the form of their salts. N-Nonanoyl- and N-isononanoyl succinimide are preferred acylimides. N,N,N′,N′-Tetraacetylethylenediamine (TAED) is one of the particularly preferred compounds.

Bleach activators of the sulfonyl phenyl ester type preferably correspond to the cited compounds according to formula (III), wherein in this case X stands for a phenoxy group substituted by a sulfonic acid group or the alkali metal salt thereof, and n is particularly 1. The particularly preferred compounds of this type include sodium nonanoyloxybenzene sulfonate, sodium isononanoyloxybenzene sulfonate and sodium lauroyloxybenzene sulfonate.

Bleach activators of the type that correspond to quaternary nitrogen substituted acetonitriles, preferably correspond to the formula (IV),

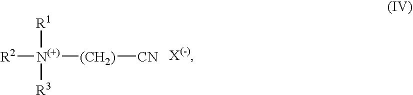

in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkyl or alkenylaryl group having a C₁₋₂₄ alkyl group or for a substituted alkyl or alkenylaryl group having a C₁₋₂₄ alkyl group and at least a further substituent on the aromatic ring, R² and R³, independently of one another, are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion. Among these, cationic nitriles are preferred, in which R¹ stands for methyl, ethyl, propyl, isopropyl or an n-butyl, n-hexyl, n-octyl, n-decyl, n-dodecyl, n-tetradecyl, n-hexadecyl or n-octadecyl group, and R² and R³ are selected from methyl, ethyl, propyl, isopropyl and hydroxyethyl, wherein advantageously one or both of these groups can also be a cyanomethyl group. The addition of trimethyl ammonium acetonitrile salts, for example the chlorides, sulfates, hydrogen sulfates, metho- or ethosulfates, is particularly preferred.

In a preferred embodiment of the invention, a composition according to the invention comprises 0.5 wt. % to 10 wt. %, particularly 1 wt. % to 8 wt. % bleach activator of the cited types. It is particularly preferred when bleach activators of the amide type and bleach activators of the type of quaternary nitrogen substituted acetonitriles are present together.

For use in particulate detergents, cleansing compositions and disinfectants, the substances used in combination according to the invention are preferably solid at room temperature. The compounds according to formula I or formula II are used in combination with the cited bleach activators preferably for bleaching colored stains when washing fabrics, particularly in aqueous, surfactant-containing liquor. In this context, the wording “bleaching colored stains” is to be understood in the broadest sense and includes both the bleaching of dirt that is found on the fabric, the bleaching of dirt that is present in the wash liquor as well as the oxidative decomposition of fabric colors present in the wash liquor, which are removed from the fabric under the washing conditions before they can be absorbed onto other colored fabrics. Also, for the use in cleaning solutions for hard surfaces, in particular for dishes, the term bleach is understood to mean both bleaching dirt that is found on the hard surfaces, particularly tea, as well as bleaching dirt that has been removed from the hard surfaces and is present in the dishwasher liquor.

In the inventive process and in the scope of an inventive use, the combination can be employed whenever a particular increase in the oxidizing action, particularly of inorganic peroxygen compounds at low temperatures is needed, for example when bleaching fabrics, hair or hard surfaces, when oxidizing organic or inorganic intermediates and for disinfection.

The inventive use essentially consists in creating conditions under which the peroxygen compound can react with the compounds employed in the combination with the object of obtaining secondary products that are strongly oxidizing. In particular, such conditions are present when the reaction partners interact in aqueous solution. This can occur by separately adding the peroxygen compound, the compound according to formula (I) and/or formula (II) in separate form to a solution of detergent or cleansing agent as the case may be. However, the inventive process is advantageously carried out by using an inventive detergent agent, cleansing agent or disinfectant agent that comprises the cited ingredients. The peroxygen compound can also be added as such or preferably as an aqueous solution or suspension to the solution of detergent agent, cleansing agent or disinfectant agent when a peroxygen-free agent is used.

The conditions can be widely varied depending on the end use. Thus, besides pure aqueous solutions, mixtures of water and suitable organic solvents can be considered. In general, the amounts of added peroxygen compounds are chosen such that between 10 ppm and 10% active oxygen, preferably between 50 ppm and 5000 ppm active oxygen are present in the solutions.

The inventive detergents, cleansing compositions and disinfectants which can be present as powdery solids, in the form of post-compacted particles, as homogeneous solutions or suspensions, can comprise in principle all known and customary ingredients for such agents in addition to the inventively used combination. In particular, the inventive detergents and cleansing compositions can comprise builders, additional surface active surfactants, water-miscible organic solvents, enzymes, sequestrants, electrolytes, pH adjusters, polymers with special effects, such as soil release polymers, color transfer inhibitors, graying inhibitors, crease-reducing polymers and shape-retaining agents, and further auxiliaries, such as optical brighteners, foam regulators, additional peroxygen activators, colorants and fragrances.

In addition to the previously cited ingredients, a disinfectant composition according to the invention can comprise customary antimicrobials for boosting the disinfection action, for example against specific germs. Such antimicrobial additives are preferably comprised in the disinfectants according to the invention in amounts of up to 10 wt. %, particularly from 0.1 wt. % to 5 wt. %.

Typical substances of the type mentioned above that form peroxycarboxylic acids or peroxyimidoacids under the perhydrolysis conditions and/or customary bleach-activating transition metal complexes can be additionally added to the combination to be used according to the invention.

The compositions according to the invention can comprise one or more surfactants, wherein anionic surfactants, non-ionic surfactants and their mixtures particularly come into question. Suitable non-ionic surfactants are particularly alkyl glycosides and ethoxylation and/or propoxylation products of alkyl glycosides or linear or branched alcohols, each with 12 to 18 carbon atoms in the alkyl moiety and 3 to 20, preferably 4 to 10 alkyl ether groups. Moreover, corresponding ethoxylation and/or propoxylation products of N-alkylamines, vicinal diols, fatty acid esters and fatty acid amides, which in regard to the alkyl moiety correspond to the cited long chain alcohol derivatives, as well as alkyl phenols with 5 to 12 carbon atoms in the alkyl group can be used.

Suitable anionic surfactants are particularly soaps and such that comprise sulfate or sulfonate groups, preferably with alkali metal ions as the cations. Useable soaps are preferably the alkali metal salts of the saturated or unsaturated fatty acids with 12 to 18 carbon atoms. These types of fatty acids can also be used in a not completely neutralized form. The useable surfactants of the sulfate type include the salts of sulfuric acid half esters of fatty alcohols with 12 to 18 carbon atoms and the sulfation products of the mentioned non-ionic surfactants with a low degree of ethoxylation. The useable surfactants of the sulfonate type include linear alkylbenzene sulfonates with 9 to 14 carbon atoms in the alkyl moiety, alkyl sulfonates with 12 to 18 carbon atoms, as well as olefin sulfonates with 12 to 18 carbon atoms, which result from the reaction of corresponding monoolefins with sulfur trioxide, as well as a-sulfofatty acids that result from the sulfonation of fatty acid methyl or ethyl esters.

These types of surfactants are preferably comprised in the cleansing compositions or detergents according to the invention in amounts of 5 wt. % to 50 wt. %, particularly 8 wt. % to 30 wt. %, whereas the disinfectant compositions according to the invention as well as the cleansing compositions according to the invention comprise preferably 0.1 wt. % to 20 wt. %, particularly 0.2 to 5 wt. % surfactants.

A composition according to the invention preferably comprises at least one water-soluble and/or water-insoluble organic and/or inorganic builder. Suitable dispersion agents include polycarboxylic acids, particularly citric acid and sugar acids, monomeric and polymeric amino polycarboxylic acids, particularly polyaspartic acid, polyphosphonic acids, particularly amino tris(methylenephosphonic acid), ethylenediaminetetrakis(methylenephosphonic acid) and 1-hydroxyethane-1,1-diphosphonic acid, polymeric hydroxyl compounds such as dextrin as well as polymeric (poly)carboxylic acids, particularly those polycarboxylates obtained from the oxidation of polysaccharides or dextrins according to international patent application WO 93/16110 or international patent application WO 92/18542 or the European Patent EP 0 232 202, polymeric acrylic acids, methacrylic acids, maleic acids and mixed polymers thereof, which can also comprise small amounts of copolymerized polymerizable substances exempt from carboxylic acid functionality. The relative molecular weight of the homopolymers of unsaturated carboxylic acids lies generally between 5000 and 200 000 that of the copolymers between 2000 and 200 000, preferably 50 000 to 120 000, each based on the free acid. A particularly preferred acrylic acid-maleic acid copolymer has a relative molecular weight of 50 000 to 100 000. Suitable, yet less preferred compounds of this class, are copolymers of acrylic acid or methacrylic acid with vinyl ethers, such as vinyl methyl ethers, vinyl esters, ethylene, propylene and styrene, in which the content of the acid is at least 50 wt. %. Terpolymers, which comprise two unsaturated acids and/or their salts as monomers as well as vinyl alcohol and/or an esterified vinyl alcohol or a carbohydrate as the third monomer, can also be used as water-soluble organic builders. The first acid monomer or its salt is derived from a monoethylenically unsaturated C₃-C₈ carboxylic acid and preferably from a C₃-C₄ monocarboxylic acid, particularly from (meth)acrylic acid. The second acidic monomer or its salt can be a derivative of a C₄-C₈ dicarboxylic acid, maleic acid being particularly preferred, and/or a derivative of an allyl sulfonic acid, which is substituted in the 2-position with an alkyl or aryl group. These types of polymers can be manufactured particularly according to the processes, which are described in the German Patent DE 42 21 381 and the German Patent application DE 43 00 772, and generally have a relative molecular weight between 1000 and 200 000. Further preferred copolymers are those, which are described in the German Patent applications DE 43 03 320 and DE 44 17 734 and preferably have acrolein and acrylic acid/acrylic acid salts or vinyl acetate as monomers. The organic builders, especially for the manufacture of liquid agents, can be added in the form of aqueous solutions, preferably in the form of 30- to 50 weight percent aqueous solutions. In general, all the cited acids are added in the form of their water-soluble salts, particularly their alkali metal salts.

These types of organic builders can be comprised as desired in amounts of up to 40 wt. %, particularly up to 25 wt. % and preferably from 1 wt. % to 8 wt. %. Amounts close to the cited upper limit are preferably added in pasty or liquid, particularly aqueous, compositions according to the invention.

The water-soluble inorganic builders particularly concern polymeric alkali metal phosphates that can be present in the form of their alkaline, neutral or acidic sodium or potassium salts. Examples are tetrasodium diphosphate, disodium dihydrogen diphosphate, pentasodium triphosphate, so-called sodium hexametaphosphate as well as the corresponding potassium salts or mixtures of sodium and potassium salts. In particular, crystalline or amorphous alkali metal aluminosilicates in amounts of up to 50 wt. %, preferably not more than 40 wt. % and in liquid agents not more than 1 wt. % to 5 wt. % are added as the water-insoluble, water-dispersible inorganic builders. Among these, the detergent-quality crystalline sodium aluminosilicates, particularly zeolites A, P and optionally X, are preferred. Amounts close to the cited upper limit are preferably added in solid, particulate agents. Suitable aluminosilicates particularly exhibit no particles with a particle size above 30 μm and preferably consist of at least 80 wt. % of particles smaller than 10 μm. Their calcium binding capacity, which can be determined according to the indications of German patent DE 24 12 837, generally lies in the range 100 to 200 mg CaO per gram.

Suitable substitutes or partial substitutes for the cited aluminosilicate are crystalline alkali metal silicates that can be alone or present in a mixture with amorphous silicates. The alkali metal silicates that can be used as builders in the inventive agents preferably have a molar ratio of alkali metal oxide to SiO₂ below 0.95, particularly 1:1.1 to 1:12 and can be amorphous or crystalline. Preferred alkali metal silicates are the sodium silicates, particularly the amorphous sodium silicates, with a molar ratio Na₂O:SiO₂ of 1:2 to 1:2.8. Those with a molar ratio Na₂O:SiO₂ of 1:1.9 to 1:2.8 can be manufactured according to the process of the European patent application EP 0 425 427. Crystalline silicates that can be present alone or in a mixture with amorphous silicates are preferably crystalline, layered silicates corresponding to the general formula Na₂SiₓO₂ₓ₊₁y.H₂O, wherein x, the so-called module is a number from 1.9 to 4 and y is a number from 0 to 20, preferred values for x being 2, 3 or 4. Crystalline layered silicates, which correspond to this general formula, are described, for example, in the European patent application EP 0 164 514. Preferred crystalline layered silicates are those in which x assumes the values 2 or 3 in the cited general formula. Both β- and δ-sodium disilicate Na₂Si₂O₅ y H₂O are particularly preferred, wherein β-sodium disilicate can be obtained for example from the process described in the international patent application WO 91/08171. δ-Sodium silicates with a module between 1.9 and 3.2 can be manufactured according to the Japanese patent applications JP 04/238 809 or JP 04/260 610. Practically anhydrous crystalline alkali metal silicates of the abovementioned general formula, in which x is a number from 1.9 to 2.1 can also be manufactured from amorphous alkali metal silicates, as described in the European patent applications EP 0 548 599, EP 0 502 325 and EP 0 425 428, and can be used in the compositions according to the invention. In a further preferred embodiment of the inventive agent, a crystalline sodium layered silicate with a module of 2 to 3 is added, as can be manufactured from sand and soda according to the European patent application EP 0 436 835. In a further preferred embodiment of the inventive agent, crystalline sodium silicates with a module of 1.9 to 3.5 are added, as manufactured from the processes of the European patents EP 0 164 552 and/or EP 0 294 753. In a preferred embodiment of the inventive agent, a granular compound of alkali metal silicate and alkali metal carbonate is added, as is described, for example, in the international patent application WO 95/22592 or as is commercially available, for example under the name Nabion® 15. In the case that alkali metal aluminosilicate, in particular zeolite is also present as the additional builder, then the weight ratio aluminosilicate to silicate, each based on the anhydrous active substances, is preferably 1:10 to 10:1. In agents that comprise both amorphous and crystalline alkali metal silicates, the weight ratio of amorphous alkali metal silicate to crystalline alkali metal silicate is preferably 1:2 to 2:1 and particularly 1:1 to 2:1.

Builders are preferably comprised in the detergents or cleansing compositions according to the invention in amounts of up to 60 wt. %, particularly from 5 wt. % to 40 wt. %, whereas the disinfectants according to the invention are preferably free from the components of the water hardness complexing builders and preferably comprise not more than 20 wt. %, particularly from 0.1 to 5 wt. % of heavy metal-complexants, preferably from the group including amino polycarboxylic acids, amino polyphosphonic acids and hydroxy polyphosphonic acids and their water-soluble salts as well as their mixtures.

In a preferred embodiment of the invention, a composition according to the invention includes a water-soluble builder block. The use of the term “builder block” is intended to emphasize that the compositions do not comprise other builders than water-soluble builders, i.e. all of the builders comprised in the agent are summarized in the stated “block”, wherein at the most, allowance is made for the amounts of materials that can be comprised in the customary ingredients of commercial agents as impurities or minor amounts of added stabilizers. The term “water-soluble” is intended to mean that the builder block, in the amount comprised in the agent, in normal conditions, dissolves without residue. The compositions according to the invention preferably comprise at least 15 wt. % and up to 55 wt. %, particularly 25 wt. % to 50 wt. %, of water-soluble builder block. They are preferably composed of the components

a) 5 wt. % to 35 wt. % of citric acid, alkali metal citrate and/or alkali metal carbonate that can be replaced at least in part by alkali metal hydrogen carbonate,
b) up to 10 wt. % alkali metal silicate with a module in the range 1.8 to 2.5,
c) up to 2 wt. % phosphonic acid and/or alkali metal phosphonate,
d) up to 50 wt. % alkali metal phosphate, and
e) up to 10 wt. % polymeric polycarboxylate,
wherein the quantities are based on the total detergent or cleansing composition. This is also true for all of the following quantities, when not otherwise stated.

In a preferred embodiment of the composition according to the invention, the water-soluble builder block comprises at least 2 of the components b), c), d) and e) in amounts of greater than 0 wt. %.

With regard to component a), in a preferred embodiment of the composition according to the invention, are comprised 15 wt. % to 25 wt. % alkali metal carbonate that can be replaced at least in part by alkali metal hydrogen carbonate, and up to 5 wt. %, particularly 0.5 wt. % to 2.5 wt. % citric acid and/or alkali metal citrate. In an alternative embodiment of the composition according to the invention, the component a) comprises 5 wt. % to 25 wt. %, particularly from 5 wt. % to 15 wt. % citric acid and/or alkali metal citrate and up to 5 wt. %, particularly from 1 wt. % to 5 wt. % alkali metal carbonate that can be replaced at least in part by alkali metal hydrogen carbonate. If both alkali metal carbonate and also alkali metal hydrogen carbonate are present, then the component a) preferably includes alkali metal carbonate and alkali metal hydrogen carbonate in the weight ratio of 10:1 to 1:1.

With regard to component b), in a preferred embodiment of the composition according to the invention, there are comprised 1 wt. % to 5 wt. % alkali metal silicate with a modulus in the range 1.8 to 2.5.

With regard to component c), in a preferred embodiment of the composition according to the invention, there are comprised 0.05 wt. % to 1 wt. % phosphonic acid and/or alkali metal phosphonate. Phosphonic acids are also understood to include optionally substituted alkyl phosphonic acids that may possess a plurality of phosphonic acid groups (so-called polyphosphonic acids). They are preferably selected from the hydroxy and/or aminoalkyl phosphonic acids and/or their alkali metal salts, such as, for example, dimethylaminomethane diphosphonic acid, 3-aminopropane-1-hydroxy-1,1-diphosphonic acid, 1-amino-1-phenyl-methane diphosphonic acid, 1-hydroxyethane-1,1-diphosphonic acid, amino-tris(methylene phosphonic acid), N,N,N′,N′-ethylenediamine-tetrakis(methylene phosphonic acid) and the acetylated derivatives of the phosphorous acids described in the German patent DE 11 07 207, which can also be employed in any mixtures.

With regard to component d), in a preferred embodiment of the composition according to the invention, there are comprised 15 wt. % to 35 wt. % alkali metal phosphate, in particular trisodium polyphosphate. “Alkali metal phosphate” is the collective term for the alkali metal (more particularly sodium and potassium) salts of the various phosphoric acids, in which metaphosphoric acids (HPO₃)ₙ and orthophosphoric acid (H₃PO₄) can be differentiated among representatives of higher molecular weight. The phosphates combine several inherent advantages: They act as alkalinity sources, prevent lime deposits on machine parts and lime incrustations in fabrics and, in addition, contribute towards the cleansing power. Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H₂P₂O₇) and, at higher temperatures into sodium trimetaphosphate (Na₃P₃O₉) and Maddrell's salt. NaH₂PO₄ shows an acidic reaction. It is formed by adjusting phosphoric acid with sodium hydroxide to a pH value of 4.5 and spraying the resulting “mash”. Potassium dihydrogen phosphate (primary or monobasic potassium phosphate, potassium biphosphate, KDP), KH₂PO₄, is a white salt with a density of 2.33 gcm⁻³, has a melting point of 253° C. [decomposition with formation of potassium polyphosphate (KPO₃)ₓ] and is readily soluble in water. Disodium hydrogen phosphate (secondary sodium phosphate), Na₂HPO₄, is a colorless, very readily water-soluble crystalline salt. It exists in anhydrous form and with 2 mol (density 2.066 gcm⁻³, water loss at 95° C.), 7 mol (density 1.68 gcm⁻³, melting point 48° with loss of 5H₂O) and 12 mol of water (density 1.52 gcm⁻³, melting point 35° with loss of 5H₂O), becomes anhydrous at 100° and, on fairly intensive heating, is converted into the diphosphate Na₄P₂O₇. Disodium hydrogen phosphate is prepared by neutralization of phosphoric acid with soda solution using phenolphthalein as the indicator. Dipotassium hydrogen phosphate (secondary or dibasic potassium phosphate), K₂HPO₄, is an amorphous white salt, which is readily soluble in water. Trisodium phosphate, tertiary sodium phosphate, Na₃PO₄, are colorless crystals with a density of 1.62 gcm⁻³ and a melting point of 73-76° C. (decomposition) as the dodecahydrate; as the decahydrate (corresponding to 19-20% P₂O₅) a melting point of 100° C., and in anhydrous form (corresponding to 39-40% P₂O₅) a density of 2.536 gcm⁻³. Trisodium phosphate is readily soluble in water with an alkaline reaction and is manufactured by evaporating a solution of exactly 1 mole disodium phosphate and 1 mole NaOH. Tripotassium phosphate (tertiary or tribasic potassium phosphate), K₃PO₄, is a white deliquescent granular powder with a density of 2.56 gcm⁻³, has a melting point of 1340° C. and is readily soluble in water through an alkaline reaction. It is produced by e.g. heating Thomas slag with carbon and potassium sulfate. Despite their higher price, the more readily soluble and therefore highly effective potassium phosphates are often preferred to corresponding sodium compounds in the detergent industry. Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm⁻³, melting point 94° C. with loss of water). Both substances are colorless crystals that dissolve in water with an alkaline reaction. Na₄P₂O₇ is formed when disodium phosphate is heated to more than 200° C. or by reacting phosphoric acid with soda in a stoichiometric ratio and spray drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, which is soluble in water, the pH of a 1% solution at 25° C. being 10.4. Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. In particular, the latter are known by various different names: fused or calcined phosphates, Graham's salt, Kurrol's salt and Maddrell's salt. All higher sodium and potassium phosphates are known collectively as condensed phosphates. The industrially important pentasodium triphosphate, Na₅P₃O₁₀ (sodium tripolyphosphate), is anhydrous or crystallizes with 6H₂O to a non-hygroscopic white water-soluble salt which and which has the general formula NaO—[P(O)(ONa)—O]ₙ—Na where n=3. Around 17 g of the salt free from water of crystallization dissolve in 100 g of water at room temperature, around 20 g at 60° C. and around 32 g at 100° C. After heating the solution for 2 hours to 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray-dried. Similarly to Graham's salt and sodium diphosphate, pentasodium triphosphate solubilizes many insoluble metal compounds (including lime soaps, etc.). K₅P₃O₁₀ (potassium tripolyphosphate) is marketed for example in the form of a 50% by weight solution (>23% P₂O₅, 25% K₂O). The potassium polyphosphates are widely used in the detergent industry. Sodium potassium tripolyphosphates also exist and are also usable in the scope of the present invention. They are formed for example when sodium trimetaphosphate is hydrolyzed with KOH:

(NaPO₃)₃+2KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

With regard to component e), in a preferred embodiment of the composition according to the invention, there are comprised 1.5 wt. % to 5 wt. % of polymeric polycarboxylate, particularly selected from the polymerization or copolymerization products of acrylic acid, methacrylic acid and/or maleic acid. Among these are the homopolymers of acrylic acid and more specifically those with an average molecular weight in the range of 5000 D to 15 000 D (PA standard) are again particularly preferred.

Apart from the abovementioned oxidases, enzymes that can be used in the compositions are those from the class of proteases, lipases, cutinases, amylases, pullulanases, mannanases, cellulases, hemicellulases, xylanases and peroxidases as well as their mixtures, for example proteases like BLAP®, Optimase®, Opticlean®, Maxacal®, Maxapem®, Alcalase®, Esperase®, Savinase®, Durazym® and/or Purafect® OxP, amylases like Termamyl®, Amylase-LT®, Maxamyl®, Duramyl® and/or Purafect® OxAm, lipases like Lipolase®, Lipomax®, Lumafast® and/or Lipozym®, cellulases like Celluzyme® and/or Carezyme®. Enzymatic active materials obtained from bacterial sources or fungi such as bacillus subtilis, bacillus licheniformis, streptomyceus griseus, humicola lanuginosa, humicola insolens, pseudomonas pseudoalcaligenes or pseudomonas cepacia are particularly suitable. The optionally used enzymes, described for example in the European patent EP 0 564 476 or in the international patent application WO 94/23005, can be adsorbed on carrier materials and/or embedded in encapsulants to protect them against premature inactivation. They are comprised in the inventive detergents, cleansing compositions or disinfectant compositions according to the invention preferably in amounts of up to 10 wt. %, particularly 0.2 wt. % to 2 wt. %, wherein enzymes that are stabilized against oxidative decomposition are particularly preferably employed, such as, for example, those known from the international patent applications WO 94/02597, WO 94/02618, WO 94/18314, WO 94/23053 or WO 95/07350.

In a preferred embodiment of the invention, the composition comprises 5 wt. % to 50 wt. %, particularly 8 to 30 wt. % anionic and/or non-ionic surfactant, up to 60 wt. %, particularly 5 wt. % to 40 wt. % builder and 0.2 wt. % to 2 wt. % enzyme, selected from the proteases, lipases, cutinases, amylases, pullulanases, mannanases, cellulases, oxidases and peroxidases as well as their mixtures.

Organic solvents that can be employed in the compositions according to the invention, particularly when the compositions are in liquid or paste form, include alcohols with 1 to 4 carbon atoms, particularly methanol, ethanol, isopropanol and tert.-butanol, diols with 2 to 4 carbon atoms, particularly ethylene glycol and propylene glycol, their mixtures and the ethers derived from the cited classes of compounds. These types of water-miscible solvent are preferably present in the detergents, cleansing compositions and disinfectants according to the invention in amounts of not more than 30 wt. %, particularly 6 wt. % to 20 wt. %.

To adjust a pH resulting from mixing the usual components to a desired level, the compositions according to the invention can comprise acids that are compatible with the system and the environment, particularly citric acid, acetic acid, tartaric acid, malic acid, glycolic acid, succinic acid, glutaric acid and/or adipic acid, and also mineral acids, particularly sulfuric acid or bases, particularly ammonium hydroxide or alkali metal hydroxides. These types of pH adjustors are preferably comprised in the compositions according to the invention in amounts of not more than 20 wt. %, particularly 1.2 wt. % to 17 wt. %.

“Soil release” polymers or soil release substances that provide the treated surface of fibers, for example, with soil repellency are known as “soil repellents” and are non-ionic or cationic cellulose derivatives, for example. In particular, the active polyester soil release polymers include copolyesters of dicarboxylic acids, for example adipic acid, phthalic acid or terephthalic acid, diols, for example ethylene glycol or propylene glycol, and polydiols, for example polyethylene glycol or polypropylene glycol. The preferred soil release polyesters employed include such compounds that are formally obtained by the esterification of two monomeric moieties, wherein the first monomer is a dicarboxylic acid HOOC-Ph-COOH and the second monomer is a diol HO—(CHR¹¹—)ₐOH, that can also be present as a polymeric diol H—(O—(CHR¹¹—)ₐ)_{b}OH. Here, Ph means a o-, m- or p-phenyl group that can carry 1 to 4 substituents selected from alkyl groups with 1 to 22 carbon atoms, sulfonic acid groups, carboxyl groups and their mixtures, R¹¹ is hydrogen, an alkyl group with 1 to 22 carbon atoms and their mixtures, a is a number from 2 to 6 and b is a number from 1 to 300. Preferably, both monomer diol units —O—(CHR₁₁—)ₐO— and also polymeric diol units —(O—(CHR¹¹—)ₐ)_{b}O— are present in the resulting polyesters. The molar ratio of monomeric diol units to polymeric diol units preferably ranges from 100:1 to 1:100, particularly 10:1 to 1:10. The degree of polymerization b of the polymeric diol units is preferably in the range from 4 to 200, particularly from 12 to 140. The molecular weight or the average molecular weight or the maximum of the molecular weight distribution of preferred soil release polyesters is in the range from 250 to 100 000, particularly from 500 to 50 000. The acid based on the Ph group is preferably selected from terephthalic acid, isophthalic acid, phthalic acid, trimellitic acid, mellitic acid, the isomers of sulfo phthalic acid, sulfo isophthalic acid and sulfo terephthalic acid and their mixtures. As long as their acid groups are not part of the ester linkages in the polymer, then they are preferably present in salt form, particularly as alkali metal or ammonium salts. Among these, sodium and potassium salts are particularly preferred. If desired, instead of the monomer HOOC-Ph-COOH, small amounts, particularly not more than 10 mol % of other acids that possess at least two carboxyl groups, based on the fraction of Ph with the abovementioned meaning, can be comprised in the soil release polyester. Exemplary alkylene and alkenylene dicarboxylic acids include malonic acid, succinic acid, fumaric acid, maleic acid, glutaric acid, adipic acid, pimelic acid, suberic acid, azelaic acid and sebacic acid. The preferred diols HO—(CHR¹¹—)ₐOH include those in which R¹¹ is hydrogen and a is a number from 2 to 6, and those in which a has the value 2 and R¹¹ is selected from hydrogen and alkyl groups with 1 to 10, particularly 1 to 3 carbon atoms. The last named diols are particularly preferably those of the formula HO—CH₂—CHR¹¹—OH, in which R¹¹ has the abovementioned meaning. Exemplary diol components are ethylene glycol, 1,2-propylene glycol, 1,3-propylene glycol, 1,4-butane diol, 1,5-pentane diol, 1,6-hexane diol, 1,8-octane diol, 1,2-decane diol, 1,2-dodecane diol and neopentyl glycol. Polyethylene glycol with an average molecular weight of 1000 to 6000 is particularly preferred among the polymeric diols. If desired, these polyesters can be end blocked, wherein the blocking groups can be alkyl groups with 1 to 22 carbon atoms and esters of monocarboxylic acids. The blocking groups bonded through ester linkages can be based on alkyl, alkenyl and aryl monocarboxylic acids with 5 to 32 carbon atoms, particularly 5 to 18 carbon atoms. They include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, elaiostearic acid, arachic acid, gadoleic acid, arachidonic acid, behenic acid, erucic acid, brassidic acid, clupanodonic acid, lignoceric acid, cerotic acid, melissic acid, benzoic acid that can carry 1 to 5 substituents with a total of up to 25 carbon atoms, particularly 1 to 12 carbon atoms, for example tert.-butylbenzoic acid. The blocking groups can also be based on hydroxymonocarboxylic acids with 5 to 22 carbon atoms, examples of which include hydroxyvaleric acid, hydroxycaproic acid, ricinoleic acid, its hydrogenation product hydroxystearic acid and o-, m- and p-hydroxybenzoic acid. The hydroxymonocarboxylic acids can themselves be linked with one another through their hydroxyl group and their carboxyl group and thus be present several fold in an end group. Preferably, the number of hydroxymonocarboxylic acid units per end group, i.e. the degree of oligomerization, is in the range 1 to 50, particularly 1 to 10. In a preferred embodiment of the invention, polymers of ethylene terephthalate and polyethylene oxide terephthalate are used, in which the polyethylene glycol units have a molecular weight 750 to 5000 and the molar ratio of ethylene terephthalate to polyethylene oxide terephthalate is 50:50 to 90:10, alone or in combination with cellulose derivatives.

Color transfer inhibitors that can be used in inventive agents for washing textiles particularly include polyvinyl pyrrolidones, polyvinyl imidazoles, polymeric N-oxides such as polyvinyl pyridine-N-oxide and copolymers of vinyl pyrrolidone with vinyl imidazole and optionally further monomers.

As fabric surfaces, particularly of rayon, spun rayon, cotton and their mixtures, can crease of their own accord because the individual fibers are sensitive to flection, bending, pressing and squeezing at right angles to the fiber direction, the compositions according to the invention can comprise anti-crease agents. They include for example synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

Graying inhibitors have the task of ensuring that the dirt removed from the hard surface and particularly from the textile fibers is held suspended in the wash liquid. Water-soluble colloids of mostly organic nature are suitable for this, for example starch, glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, aldehyde starches, for example, can be used instead of the abovementioned starch derivatives. Preference, however, is given to the use of cellulose ethers such as carboxymethyl cellulose (Na salt), methyl cellulose, hydroxyalkyl cellulose, and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the agent.

The compositions may comprise optical brighteners, in particular derivatives of diaminostilbene disulfonic acid or alkali metal salts thereof. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group, an anilino group or a 2-methoxyethylamino group instead of the morpholino group. Optical brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned optical brighteners may also be used.

Particularly when used in automatic washing and cleaning processes, it can be advantageous to add conventional foam inhibitors to the compositions. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanized silica and also paraffins, waxes, microcrystalline waxes and mixtures thereof with silanized silica or bis-fatty acid alkylenediamide. Mixtures of various foam inhibitors, for example mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis stearylethylene diamide are preferred.

Furthermore, active substances to prevent tarnishing of silver objects, so-called silver corrosion inhibitors, can be added to the compositions according to the invention. Preferred silver corrosion inhibitors are organic disulfides, dihydric phenols, trihydric phenols, optionally alkyl or aminoalkyl substituted triazoles such as benzotriazole and salts and/or complexes of cobalt, manganese, titanium, zirconium, hafnium, vanadium, or cerium, in which the cited metals are present in the valence states II, III, IV, V or VI.

The terpyridine compound that is able to form complexes with iron and manganese ions, and the corresponding pre-prepared iron or manganese complexes can be present in the form of powders or as granulates that can also be optionally coated and/or colored and can comprise conventional carrier materials and/or granulation auxiliaries. In the case that they are used in granular form, they can also comprise, if desired, bleach activators of the amide type, the sulfonyl phenyl ester type or the quaternary nitrogen-substituted acetonitrile type.

The manufacture of solid compositions according to the invention is not difficult and in principle can be made by known methods, for example by spray drying or granulation, wherein the peroxygen compounds and bleach activator combinations are optionally added later. For manufacturing compositions according to the invention with an increased bulk density, particularly in the range of 650 g/l to 950 g/l, a preferred process is one with an extrusion step, known from the European Patent EP 0 486 592. Detergents, cleansing compositions or disinfectants according to the invention in the form of aqueous solutions or other solutions comprising standard solvents are particularly advantageously manufactured by a simple mixing of the ingredients, which can be added into an automatic mixer as such or as a solution. In a preferred embodiment of compositions, in particular for automatic dishwashing, they are in tablet form and can be manufactured in accordance with the process disclosed in the European patents EP 0 579 659 and EP 0 591 282.

1-15. (canceled)

16. A composition comprising: (i) a peroxygen-containing bleaching agent, (ii) a bleach activator selected from the group consisting of amide bleach activators, sulfonyl phenyl ester bleach activators, quaternary nitrogen substituted acetonitrile bleach activators, and mixtures thereof, and (iii) a compound selected from the group consisting of ligands corresponding to the general formula (I), bleach catalysts corresponding to the general formula (II), and mixtures thereof: 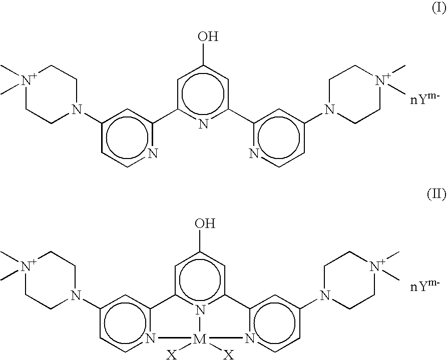
wherein Y^{m-} represents an anion, M represent a manganese or iron atom, each X independently represents an inorganic ligand and the mathematical product of m and n equals 2.

17. The composition according to claim 16, wherein the compound comprises a ligand corresponding to the general formula (I), and wherein the composition further comprises a metal component selected from the group consisting of manganese salts, iron salts, manganese complexes, iron complexes, and mixtures thereof, and wherein the complexes contain no bound ligands corresponding to the general formula (I).

18. The composition according to claim 17, wherein the molar ratio of manganese and iron to the ligand corresponding to the general formula (I) is 0.001:1 to 2:1.

19. The composition according to claim 16, wherein the compound comprises a ligand corresponding to the general formula (I), and wherein the ligand is present in an amount of 0.01 to 2% by weight.

20. The composition according to claim 16, wherein the compound comprises a bleach catalyst corresponding to the general formula (II), and wherein the bleach catalyst is present in an amount of 0.01 to 1.5% by weight.

21. The composition according to claims 16, wherein Y^{m-} represents an organic anion.

22. The composition according to claims 16, wherein the compound comprises a bleach catalyst corresponding to the general formula (II), and wherein each X independently represents a halide, a perchlorate, a tetrafluoroborate, a hexafluorophosphate, a nitrate, a hydrogen sulfate, a hydroxide, or a hydroperoxide.

23. The composition according to claims 16, wherein the compound comprises a bleach catalyst corresponding to the general formula (II), wherein Y^{m-} represents an organic anion, and wherein each X independently represents a halide, a perchlorate, a tetrafluoroborate, a hexafluorophosphate, a nitrate, a hydrogen sulfate, a hydroxide, or a hydroperoxide.

24. The composition according to claim 16, wherein the peroxygen-containing bleaching agent is present in an amount up to 50% by weight.

25. The composition according to claim 16, wherein the peroxygen-containing bleaching agent comprises a peroxygen compound selected from the group consisting of hydrogen peroxide, alkali metal perborates and hydrates thereof, alkali metal percarbonates, and mixtures thereof.

26. The composition according to claim 16, wherein the bleach activator is present in an amount of 0.5 to 10% by weight.

27. The composition according to claim 16, wherein the bleach activator comprises a component selected from the group consisting of acyldialkylamines, diacylalkylamines, tetraacylalkylenediamines, sodium nonanoyloxybenzene sulfonate, sodium isononanoyloxybenzene sulfonate, sodium lauroyloxybenzene sulfonate, trimethyl ammonium acetonitrile salts, and mixtures thereof.

28. The composition according to claim 16, further comprising a water-soluble builder block.

29. The composition according to claim 16, further comprising a surfactant selected from the group consisting of anionic surfactants, nonionic surfactants and combinations thereof.

30. The composition according to claim 16, further comprising an enzyme.

31. A method comprising:
(a) providing a composition comprising: (i) a peroxygen-containing bleaching agent, (ii) a bleach activator selected from the group consisting of amide bleach activators, sulfonyl phenyl ester bleach activators, quaternary nitrogen substituted acetonitrile bleach activators, and mixtures thereof, and (iii) a compound selected from the group consisting of ligands corresponding to the general formula (I), bleach catalysts corresponding to the general formula (II), and mixtures thereof: 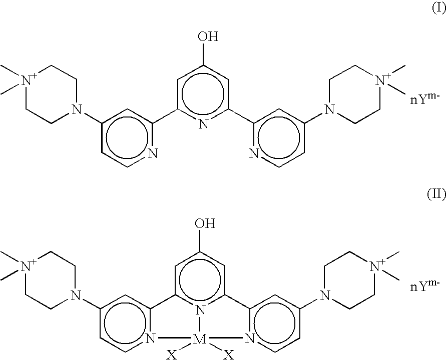
wherein Y^{m-} represents an anion, M represent a manganese or iron atom, each X independently represents an inorganic ligand and the mathematical product of m and n equals 2; and
(b) contacting a fabric to be treated with the composition.

32. The method according to claim 31, wherein contacting the fabric to be treated comprises combining the composition with a fabric washing liquor prior to or during contact between the fabric washing liquor and the fabric to be treated.

33. The method according to claim 32, wherein the compound comprises a ligand corresponding to the general formula (I), and wherein the fabric washing liquor comprises a metal ion selected from the group consisting of manganese ions, iron ions, and mixtures thereof.

34. The method according to claim 31, wherein the compound comprises a ligand corresponding to the general formula (I), and wherein the ligand is present in the composition in an amount of 0.01 to 2% by weight.

35. The method according to claim 31, wherein the compound comprises a bleach catalyst corresponding to the general formula (I), and wherein the bleach catalyst is present in the composition in an amount of 0.01 to 1.5% by weight.
